(19) United States
(12) Patent Application Publication
(10) Pub. No.: US 2011/0314258 A1
(43) Pub. Date: Dec. 22, 2011

(54) METHOD AND APPARATUS FOR OPERATING A PROGRAMMABLE LOGIC CONTROLLER (PLC) WITH DECENTRALIZED, AUTONOMOUS SEQUENCE CONTROL

(75) Inventor: Gunnar Vogel, Koblach (AT)

(73) Assignee: BACHMANN GMBH, Feldkirch (AT)

(21) Appl. No.: 12/970,050

(22) Filed: Dec. 16, 2010

(30) Foreign Application Priority Data
Dec. 16, 2009 (AT) A 1992/2009

(51) Int. Cl. G06F 15/76; G06F 9/02

(52) U.S. Cl. 712/32; 712/E09.002

(57) ABSTRACT

A method for operating a programmable logic controller (PLC), and a programmable logic controller (PLC) for a processing plant with a central data processing unit and a sequence control that reads in, processes input data from inputs, and outputs the processed output data to outputs. The data processing unit performs only superordinate administrative functions for the administration of downstream input and output modules and is embodied as an ADMIN data processing unit. The sequence control is embodied as a partial application autonomously executing in the input and output modules.

### FIELD OF THE INVENTION

The embodiments of the present invention, as disclosed, concern a decentralized, autonomous sequence control and an operating method.

### BACKGROUND

In known programmable logic controllers (PLC), the input and output modules, respectively, are designed for rudimentary functions such as, for example, analog-digital conversion, and amplification of applied analog signals, among others.

The entire intelligence is concentrated in a central data processing unit (CPU). The data processing unit reads in the raw data of the input modules, processes the raw data, and makes prepared data available to the output modules.

Disadvantages may result from the centralization of the control in the central data processing unit, such as:
Great strain on the bus system between the data processing unit and the input and output modules, respectively;
The data processing unit represents the “bottleneck” of the PLC, that is, when the data processing unit breaks down, the entire automation installation stops. The availability of an automation system is thus essentially determined by the central data processing unit;
In the event that its capacity is exhausted, the data processing unit must be replaced by a more powerful data processing unit.

Another widespread concept of the data processing of automation is shown by the disclosure of German patent application DE 10321652 A1. As disclosed in this document, a central controller transmits functions via a communication device to one or more decentralized input/output modules, which send back their status to the superordinate control. The communication device is embodied as a field bus in most cases. The input/output modules are autonomous in that they independently perform functions specific for their tasks based on their programs. These functions can be configured or reprogrammed according to the prior art. In the cited disclosure, these modules are measuring modules such as have been available for years. In automation systems, input/output modules with autonomous functions connected via communication devices have been standard for decades in the form of thermostats or as servo amplifiers.

These modules are independent devices with their own supply connection, communication connection, input/output connections, and mounting means in a machine or system, for example, by means of rail connection according to DIN EN50022.

Disadvantages may result from the distribution of individual functions of a controller via field buses to decentralized data processing units (input and output modules, respectively), such as:
Great strain on the field bus system between the controller and the input and output modules, respectively;
The field bus, as well as the data processing for the operation of the field bus, represents the “bottleneck” of the automation system, that is, when the communication is interrupted or its transmission capacity is inadequate, the entire automation installation stops. The availability of an automation system is thus essentially determined by the field bus;
If the power or necessary availability of the automation is not sufficient, a more powerful field bus or a more complex and more expensive networking architecture must be used.

### SUMMARY OF EMBODIMENTS OF THE INVENTION

Accordingly, a purpose of this invention is to further develop a programmable logic controller for a processing plant such that strain on the central data processing unit is relieved and the computing operations previously carried out by the central data processing unit are transferred to the programmable logic controller and there, in particular, to the input/output modules.

Accordingly, the communication demand between the central superordinate data processing unit and the grouped input/output modules connected to one another via an internal bus is reduced. This therefore results in a reduced dependency or lower power requirements on the communication device between the connected grouped input/output modules and the superordinate data processing unit. The communication device can be the internal system bus, via which the input/output modules are connected, as well as a field bus.

A feature of the disclosed embodiments of the present invention is that the intelligence of a central data processing unit is shifted to intelligent input and output modules. All of the input and output modules respectively are equipped with a low cost processor such as, for example, a DSP (digital signal processor).

With an input module, for example, the DSP reads in the raw data and processes them accordingly into function blocks of programmed partial applications, which thus do not need to be further processed in the central data processing unit. In the partial applications, direct or indirect physical variables are measured, monitored, regulated, and controlled according to a programmed sequence and thus are a part of the automation of the processes of a machine or installation. The shift of the “intelligence” from the central data processing unit to intelligent input and output modules, respectively, results in the following advantages:
Strain on the central data processing unit is relieved, since most of the activities are processed in the local DSPs.
A PLC can be expanded by new functions through the use of additional input and output modules respectively, without the central data processing unit being replaced for this purpose.
Redundancy can be realized through the decentralized intelligence, since an executable code runs in the DSPs in the decentralized input and output modules, respectively, wherein the same code can run in two different modules. Safety-oriented PLCs can thus also be realized thereby.
This redundancy can likewise be used to increase the availability of the entire sequence control.
The demand-oriented grouping of decentralized intelligent modules renders possible customized automation solutions for customers.

The decentralized sequence control takes place through the creation of a complete application in a development environment, wherein this application is divided up by the development environment into partial applications. This is initially administered in the start-up phase of the superordinate sequence control of the central data processing unit and then fed as an individual application via an internal system bus to the individual input/output modules which perform these applications independently due to the intelligence installed there.

A decentralized autonomous sequence control is thus formed in that individual input/output modules are part of a decentralized automation system and communicate only among themselves. Only an internal communication is maintained to fulfill the sequence control, so that the signals of the central, superordinate data processing unit are no longer important. Only a superordinate data exchange is maintained with this data processing unit, that is, monitoring functions or status changes are monitored and, if necessary, changed without, as in the prior art, this central data processing unit having a central sequence control that monitors each and every one of the downstream modules.

The inventive idea of now accommodating the autonomous controller in an automation system in a decentralized manner results in the advantage that now the modules have independent intelligence and, if the central data processing unit or the interface fails, an operation of the individual modules is nevertheless possible.

If, for example, a sequence control of this type is used in a wind power plant, in the prior art there typically was the disadvantage that, if the central data processing unit failed, all of the downstream modules were switched off and had to go into a safe mode. This led to an emergency stop, which applied all of the brakes of the wind turbine and thus caused a very high mechanical strain and possible damage.

This is avoided in the decentralized autonomous intelligence of the decentralized automation system in accordance with this invention because, despite the failure of the central data processing unit, this decentralized automation system can now be brought into a safe mode slowly and in a controlled manner without a sudden shutdown taking place. The availability of the entire installation is thus increased and much higher safety requirements can be met, since the failure of the central data processing unit does not lead to the failure of the downstream decentralized automation systems.

In one embodiment, based on the solution described above, the internal system bus can be realized redundantly. This can be used to increase the availability and the safety of the control system.

In a further embodiment the decentralized input and output modules respectively can be composed only of a data processing unit that has no connection to a superordinate control and “only” executes programs in a decentralized manner.

The invention, in an embodiment, can also be restricted to only the region of the PLC.

### BRIEF DESCRIPTION OF THE DRAWING

Examples of the invention are further described below by means of the subsequent detailed description of advantageous embodiments, reference being made to the accompanying drawing, wherein:

FIG. A is a block diagram of a sequence control according to the prior art;

FIG. B is a block diagram of a sequence control according to the prior art, modified compared to FIG. A;

FIG. 1 is a sequence control block diagram with decentralized intelligence in the start-up phase in accordance with an embodiment of the present invention;

FIG. 2 shows the sequence control according to the embodiment of FIG. 1 in the operating phase; and

FIG. 3: is a block diagram embodied in detail of a sequence control according to the embodiment of FIGS. 1 and 2.

### DETAILED DESCRIPTION OF EMBODIMENTS OF THE INVENTION

FIGS. A and B show a sequence control according to the prior art.

Sequence program 9 executes in decentralized central data processing unit (CPU) 1, which sequence program processes input data 3a via input process image 2a and, after their processing, the data are output as output data 3b via output process image 2b. Input data 3a and output data 3b are connected to the communication bus, which can be embodied as internal system bus 4, for example. A number of external modules 6 are connected to this system bus, wherein in the exemplary embodiment shown according to the prior art, external module 6 can have its own microprocessor 7 which, for example, drives regulator 12.

Microprocessor 7, via module data bus 5, exchanges desired data, actual data, and status data with central data processing unit, CPU 1, via internal system bus 4. The connection to the sensors and actuators of the system to be regulated, for example, a drive, takes place via sensor/actuator interface 8.

A block diagram of this type is shown in more detail in FIG. B, where it is discernible that the data transmitted at the communication bus are returned as actual values via data path 10 to CPU 1, and the CPU, in turn, generates desired values that are fed into module 6 via data path 11.

It is percievable that this module, with its installed sequence control, activates motor 13, the movement of which is detected by measured-value transmitter 14.

The above-referenced representation reveals a disadvantage of the prior art, because it is apparent that CPU 1 takes over all of the control functions, and downstream external module 6 performs the control commands of the central data processing unit only as a slave. However, this means that there is the drawback that, if CPU 1 fails, external module 6 suddenly enters an emergency mode and stops, whereby damage can be caused to motor 13 or to the system moved by the motor.

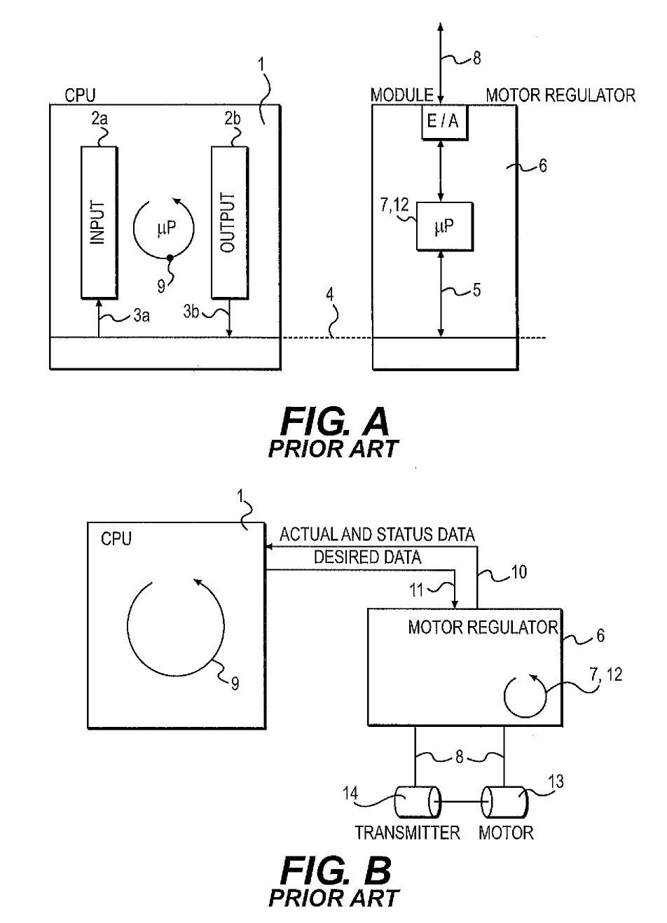

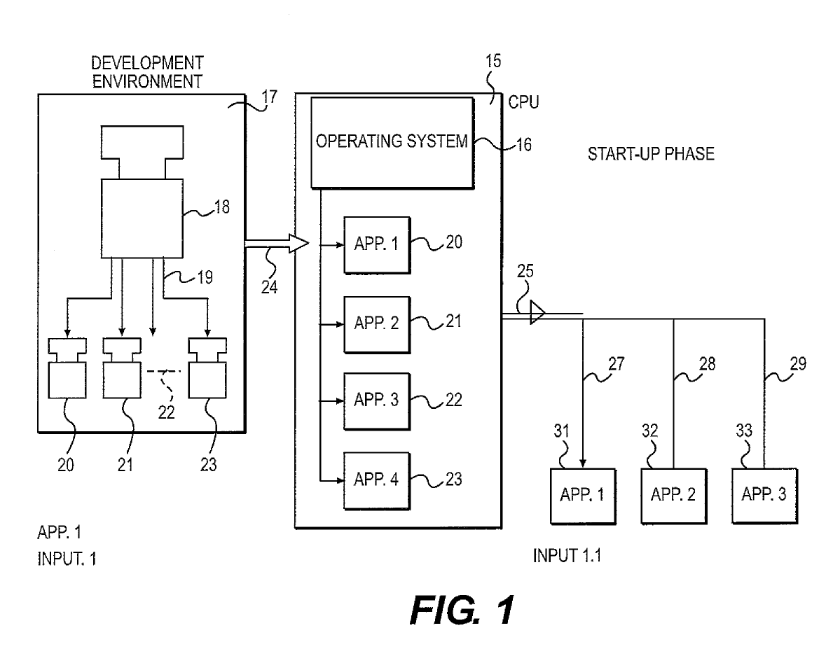

In accordance with an exemplary embodiment of the present invention, as shown in FIG. 1, a controller with a modular decentralized autonomous sequence control is used to overcome at least some of the limitations of the prior art.

FIG. 1 shows an embodiment of the current system in the start-up phase, in which it is discernible that a complete application 18 is developed in a development environment 17. The complete application is divided via divider 19 into a number of partial applications 20, 21, 22, 23. Each partial application 20-23 is an independent, separately executable program.

The partial applications 20-23 are loaded by development environment 17, for example, via programming interface 24, into the now “slimmed down” central data or ADMIN data processing unit (CPU) 15. This now has only a superordinate sequence control or operating system 16, which is considerably simplified compared to the sequence control of the general data processing unit 1, according to the prior art shown in FIGS. A and B.

The individual applications 20-23 are now stored in memory in this ADMIN data processing unit 15 and loaded into the individual input/output modules 31, 32, 33 in the arrow directions 27-29, for example, via internal system bus 25.

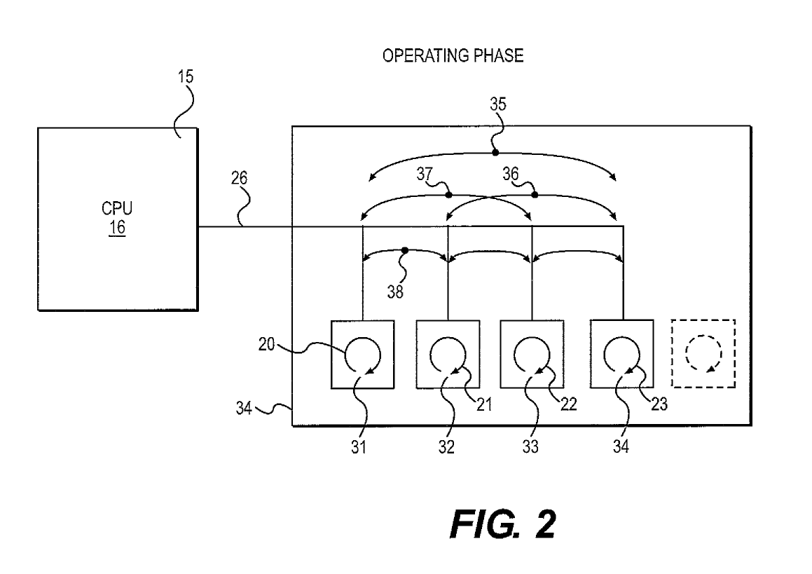

It is now important that each input/output module 31-33 is independently executable, as is shown in FIG. 2. There the simplified equivalent circuit diagram of the arrangement according to FIG. 1 is shown, and it is percievable that an individual partial application 20-21-22 is stored in an executable manner in each input/output module 31-33 and executes there so that each input/output module operates independently and functions autonomously. Of course, several partial applications can also run on a single input/output module 31-33.

The important thing is that all of the input/output modules 31-33 are arranged in a decentralized automation system 34, so that these input/output modules maintain an internal exchange of communication 35-38 only among themselves, without ADMIN data processing unit 15 having to be switched on for this purpose. This unit has only superordinate administration functions and operates as a decentralized CPU, so that decentralized automation system 34, with input/output modules 31-33, is independently executable. It thus operates autonomously.

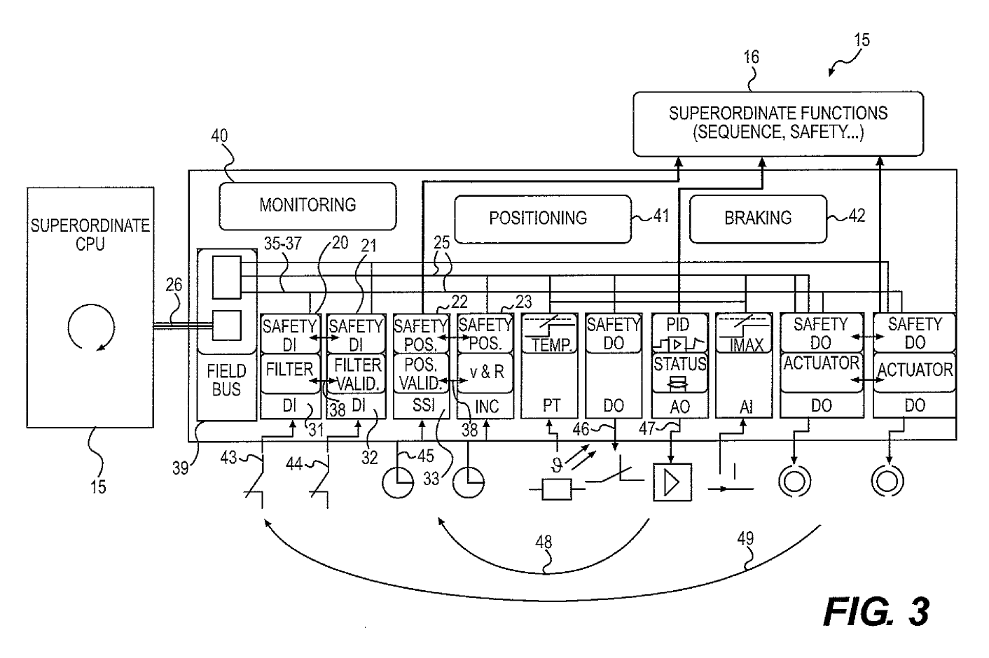

An exemplary embodiment of this type according to FIG. 2 is shown in FIG. 3. It is apparent there that the now considerably “slimmed down” ADMIN data processing unit 15 gives the superordinate data to a field bus head module 39 via communication bus 26, and field bus head module 39 supplies internal system bus 25 with data. Communication bus 26 can be a bundle of buses and can be a field bus, a proprietary data bus, or the internal system bus; in the latter case field bus head module 39 is superfluous.

All data are exchanged via internal system bus 25. The exchange of information between the partial applications is carried out independently via the internal system bus according to the information exchange demand of the partial applications. These communication exchanges 35-38 were explained based on FIG. 2.

While a plurality of input and output modules is present, only a few are described. For example, input module 31 is embodied as a digital input (DI), which is controlled by a switch as an input quantity 43, and two application programs execute in this input/output module 31, namely, a pure signal filter and a so-called safe input.

Arrows 38 running horizontally between, for example, DI 31 and DI 32, show that a communication exchange between adjacent modules takes place, which likewise is embodied as a digital input. DI 32 also contains a digital filter, the validity of which is checked with the filter of the first input and output module 31 and wherein, in turn, a switch is provided as input quantity 44.

Two different partial applications execute here, too, wherein in the third input/output module 33, a partial application executes, which generates a specific position indicator command when there is an emergency situation. Likewise with the other partial application, the valid position of a rotary encoder is detected and verified with the adjacent module via communication exchange 38. Input quantity 45 is hereby embodied as a rotary encoder.

The representation according to FIG. 3 otherwise also shows that there are digital output (DO) modules with output 46 or also analogous outputs (AO) with output 47 and that the entire output variables act back on the inputs via control paths 48, 49, as indicated by the arrows in FIG. 3.

Individual function blocks 40, 41, 42 are part of decentralized automation system 34. In the exemplary embodiment shown, function block 40, with the input/output modules shown, is used for monitoring. Function block 41, with other input/output modules, can be used for the positioning of an azimuth position of a wind turbine, for example, and function block 42 could be used to brake the rotation of a wind turbine nacelle.

It is further shown in FIG. 3 that the superordinate functions in ADMIN data processing unit 15 are monitored with superordinate sequence control 16, so that considerably fewer functions and few time-critical monitoring functions and control functions are assigned to this data processing unit, which is an advantage compared to the prior art.

This is therefore a decentralized autonomous sequence control, which executes in decentralized automation system 34 independently of a failure of ADMIN data processing unit 15.

What is claimed is:

1. A method for operating a programmable logic controller (PLC) for a processing plant having a central data processing unit (CPU), the method comprising:
reading in and processing input data from inputs and outputting the processed data to outputs by means for a sequence controller;
performing only superordinate administrative functions by the data processing unit for the administration of downstream input and output modules, the data processing unit being embodied as an ADMIN data processing unit; and
the sequence control, embodied as a partial application, executing autonomously in the input and output modules.

2. The method according to claim 1, wherein the data are loaded, processed, and transmitted with the aid of the partial applications and the input/output modules.

3. The method according to claim 1, wherein the partial applications are loaded and controlled in a decentralized manner by a superordinate sequence control.

4. The method according to claim 2, wherein the partial applications are loaded and controlled in a decentralized manner by a superordinate sequence control.

5. The method according to claim 1, and further comprising carrying out an internal communication exchange via an internal system bus via the input/output modules.

6. The method according to claim 2, and further comprising carrying out an internal communication exchange via an internal system bus via the input/output modules.

7. The method according to claim 3, and further comprising carrying out an internal communication exchange via an internal system bus via the input/output modules.

8. The method according to claim 1, and further comprising transmitting superoridnate data via a communication bus from the ADMIN data processing unit to a field bus head module coupled with an internal system bus.

9. The method according to claim 3, and further comprising transmitting superoridnate data via a communication bus from the ADMIN data processing unit to a field bus head module coupled with an internal system bus.

10. The method according to claim 1, and further comprising transmitting superoridnate data via a communication bus from the ADMIN data processing unit to a field bus head module coupled with the internal system bus.

11. The method according to claim 1, wherein a decentralized automation system executes independently of failure of the ADMIN data processing unit.

12. The method according to claim 5, wherein a decentralized automation system executes independently of failure of the ADMIN data processing unit.

13. The method according to claim 8, wherein a decentralized automation system executes independently of a failure of the communication bus.

14. The method according to claim 11, wherein the individual input/output modules are part of the decentralized automation system and communicate among themselves via the internal system bus.

15. The method according to claim 1, wherein the communication of the individual input/output modules perform via an internal system bus embodied in a redundant manner.

16. The method according to claim 1, wherein the communication of the individual input/output modules with a redundant communication bus is carried out via an internal system bus embodied in a redundant manner.

17. The method according to claim 8, wherein the communication of the individual input/output modules with the redundant communication bus is carried out via the internal system bus embodied in a redundant manner.

18. A programmable logic controller (PLC) for a processing plant, the PLC comprising:
an ADMIN data processing unit;
a superordinate sequence control that reads in input data, processes input data from the inputs, and outputs the processed data to outputs; and
a decentralized automation system with independently operating input/output modules.

19. The programmable logic controller according to claim 18, wherein said decentralized automation system comprises at least two of said input/output modules with, respectively, at least one partial application.

20. The programmable logic controller according to claim 19, wherein each partial application is its own separately executable program.

21. The programmable logic controller according to claim 18, and further comprising:
an internal communication exchange; and
an internal system bus for connecting said communication exchange and said input/output modules.

22. The programmable logic controller according to claim 19, and further comprising:
an internal communication exchange; and
an internal system bus for connecting said communication exchange and said input/output modules.

23. The programmable logic controller according to claim 18, wherein an input module of said input/output modules is configured as a digital input, which is controlled by a sensor as an input quantity.

24. The programmable logic controller according to claim 18, wherein said input/output modules can be selectively expanded without replacing said ADMIN data processing unit.

25. The programmable logic controller according to claim 18, and further comprising a communication bus selectively connecting at least one said input/output module to said ADMIN data processing unit.

26. The programmable logic controller according to claim 18, and further comprising a communication bus configured as a plurality of buses, a selective communication bus connecting said input/output modules with said ADMIN processing unit.
